(19) United States
(12) Patent Application Publication
(10) Pub. No.: US 2012/0229441 A1
(43) Pub. Date: Sep. 13, 2012

(54) LIQUID CRYSTAL DISPLAY PANEL

(75) Inventors: Chun-Chieh Wang, Chiayi County (TW); Tung-Hsin Lan, Taipei City (TW); Yu-Ting Lin, Tainan City (TW); Chia-Hua Chang, Changhua County (TW)

(73) Assignee: CHUNGHWA PICTURE TUBES, LTD., Taoyuan (TW)

(21) Appl. No.: 13/163,728

(22) Filed: Jun. 20, 2011

(30) Foreign Application Priority Data
Mar. 10, 2011 (TW) 100108116

(51) Int. Cl. G09G 3/36; G09G 5/00

(52) U.S. Cl. 345/212; 345/87

(57) ABSTRACT

A liquid crystal display (LCD) panel includes a plurality of scan lines, a plurality of data lines, a plurality of common electrode lines, a plurality of pixel units, and at least one voltage regulating chip. The pixel units are coupled to the corresponding scan lines, the corresponding data lines, and the corresponding common electrode lines, respectively. The voltage regulating chip is coupled to a regulated voltage and the common electrode lines, so as to provide a regulated current to each of the common electrode lines based on the regulated voltage, respectively.

### CROSS-REFERENCE TO RELATED APPLICATION

This application claims the priority benefit of Taiwan application serial No. 100108116, filed on Mar. 10, 2011. The entirety of the above-mentioned patent application is hereby incorporated by reference herein and made a part of this specification.

### BACKGROUND OF THE INVENTION

1. Field of the Invention

The invention relates to a liquid crystal display (LCD) panel. More particularly, the invention relates to an LCD panel that can mitigate a horizontal crosstalk phenomenon.

2. Description of Related Art

In recent years, the optoelectronic technology and the semiconductor device manufacturing technology become more mature, and therefore flat panel displays have been prosperously developed. Among the flat panel displays, an LCD is widely applied to gradually replace a conventional cathode ray tube (CRT) display and has become a mainstream display in the market due to the advantages of a low operation voltage, non-radiation, light weight, small volume occupancy, and so forth.

An LCD often includes scan lines, data lines, and a plurality of pixel structures arranged in arrays. Each of the pixel structures has a thin film transistor (TFT) and a common electrode. Owing to voltage coupling effects, parasitic capacitance is easily generated at an overlapping portion between the common electrodes and the data lines, which frequently leads to the crosstalk phenomenon of the LCD. The common electrodes are connected to the power (supplied by a printed wire board) via wires on the display panel. The longer the wires, the greater the corresponding linear impedance. Thereby, when voltages at the common electrodes which are relatively far away from the power supply are changed because of the voltage coupling effects, the voltages return to the original level in a relatively slow pace, which deteriorates the display quality of the LCD.

### SUMMARY OF THE INVENTION

The invention is directed to an LCD panel that can mitigate the crosstalk phenomenon of display images.

In an embodiment of the invention, an LCD panel that includes a plurality of scan lines, a plurality of data lines, a plurality of common electrode lines, a plurality of pixel units, and at least one voltage regulating chip is provided. The pixel units are coupled to the corresponding scan lines, the corresponding data lines, and the corresponding common electrode lines, respectively. The voltage regulating chip is coupled to a regulated voltage and the common electrode lines, so as to provide a regulated current to each of the common electrode lines based on the regulated voltage, respectively.

According to an embodiment of the invention, each voltage regulating chip includes at least one operation amplifier that is coupled between the regulated voltage and the common electrode lines, and an output end of the operation amplifier outputs the regulated current based on the regulated voltage.

According to an embodiment of the invention, the voltage regulating chip is a scan driver chip.

According to an embodiment of the invention, the scan driver chip is further coupled to the scan lines and outputs a plurality of scan signals to the scan lines to drive the pixel units.

According to an embodiment of the invention, each of the pixel units includes an active device and a liquid crystal capacitor. A control end of the active device is coupled to the corresponding scan line, and a first end of the active device is coupled to the corresponding data line. The liquid crystal capacitor is coupled between a second end of the active device and the corresponding common electrode line.

According to an embodiment of the invention, the active device is a transistor.

According to an embodiment of the invention, the LCD panel further includes at least one data driver chip that outputs a plurality of data signals to the data lines to provide the pixel units with display data.

Based on the above, the operation amplifier in the voltage regulating chip provides the regulated current to the common voltage lines at a close range, such that the voltages at the common voltage lines can return to the original level rapidly, and that the crosstalk phenomenon of images can be mitigated.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view illustrating an LCD panel according to an embodiment of the invention.

FIG. 2A is a schematic view illustrating voltage waveforms on common electrode lines of a conventional LCD panel.

FIG. 2B is a schematic view illustrating voltage waveforms on common electrode lines of the LCD panel described in the embodiment shown in FIG. 1.

FIG. 3 is a schematic view illustrating an LCD panel according to another embodiment of the invention.

### DESCRIPTION OF EMBODIMENTS

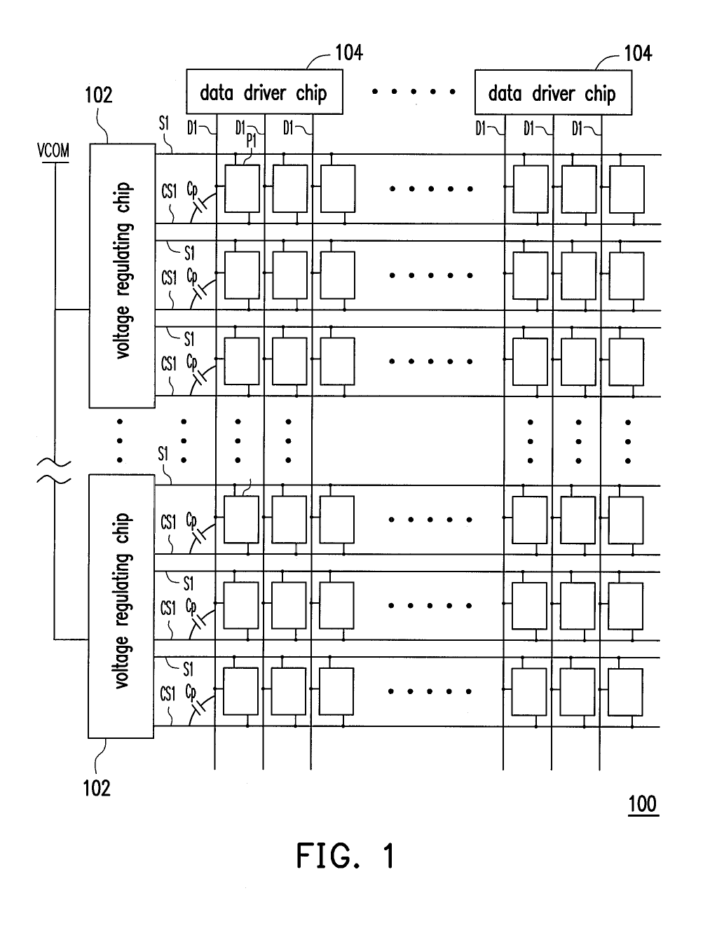

FIG. 1 is a schematic view illustrating an LCD panel according to an embodiment of the invention. The LCD panel 100 includes a plurality of scan lines S1, a plurality of data lines D1, a plurality of common electrode lines CS1, a plurality of pixel units P1, at least one voltage regulating chip 102, and at least one data driver chip 104. The pixel units P1 are coupled to the corresponding scan lines S1, the corresponding data lines D1, and the corresponding common electrode lines CS1, respectively. In the LCD panel 100, the data lines D1 and the common electrode lines CS1 are separated by an insulation layer, and therefore a parasitic capacitor Cp is formed between the data lines D1 and the common electrode lines CS1. The data lines D1 are coupled to the data driver chip 104. The common electrode lines CS1 are coupled to a common voltage VCOM via a voltage regulating chip 102. In this embodiment, the voltage regulating chip 102 can be a scan driver chip, and thus the scan lines S1 are also coupled to the voltage regulating chip 102.

The voltage regulating chip 102 (e.g., a scan driver chip in this embodiment) can output scan driving signals to the scan lines S1 during the scan period of each of the scan lines S1, so as to drive the scan lines S1 and allow the corresponding pixel units P1 to receive the data signals coming from the data driver chip 104. Images can then be displayed on the LCD panel 100. When the voltage level of the data signals which are output from the data lines D1 fluctuates according to the display data, the voltages on the common electrode lines CS1 are affected by the voltage coupling effects and accordingly jittered. At this time, the voltage regulating chip 102 can output the regulated current to the common electrode lines CS1, so as to charge or discharge the parasitic capacitor Cp. Further, the voltages on the common electrode lines CS1 can be rapidly adjusted back to the original level and regulated.

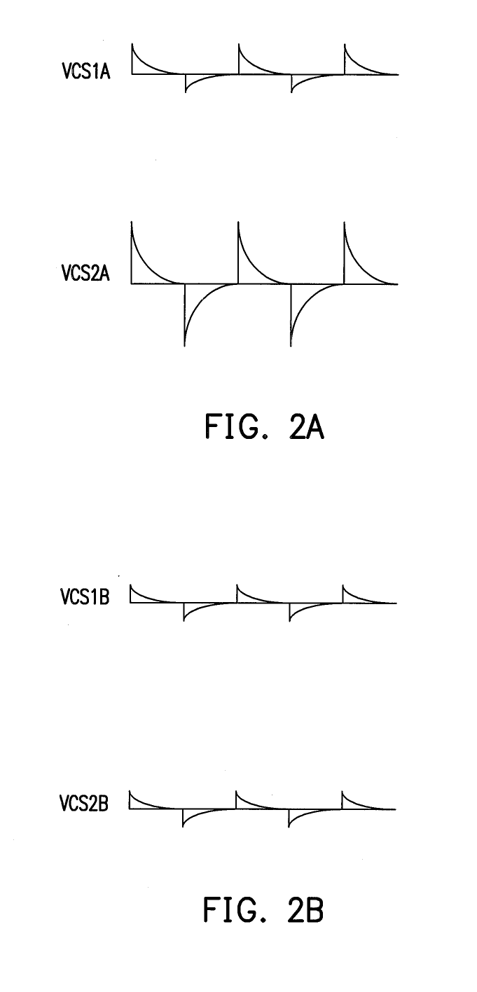

FIG. 2A is a schematic view illustrating voltage waveforms on common electrode lines of a conventional LCD panel. FIG. 2B is a schematic view illustrating voltage waveforms on common electrode lines of the LCD panel described in the embodiment shown in FIG. 1. As shown in FIG. 2A and FIG. 2B, the voltage waveforms VCS1A and VCS1B on the common electrode lines CS1 are relatively close to the common voltage VCOM, while the underlying voltage waveforms VCS2A and VCS2B on the common electrode lines CS1 are relatively away from the common voltage VCOM. With reference to FIG. 2A, if the voltage waveforms on the conventional common electrode lines CS1 are relatively away from the common voltage VCOM, the fluctuation amplitude of the voltage level is relatively apparent (i.e., the fluctuation amplitude of the voltage waveform VCS2A is greater than the fluctuation amplitude of the voltage waveform VCS1A), and more time is required for adjusting the voltages back to the normal level. In this embodiment of the invention, no matter the voltage waveforms on the common electrode lines CS1 are close to or away from the common voltage VCOM, the fluctuation amplitude of the voltage level substantially remains unchanged. Namely, the fluctuation amplitude of the voltage waveform VCS2B is substantially equal to the fluctuation amplitude of the voltage waveform VCS1B and is much less than the fluctuation amplitude described in the related art.

Accordingly, in this embodiment, the voltage regulating chip 102 provides the regulated current to the voltage input terminal of each of the common electrode lines CS1 close to the voltage regulating chip 102. Thereby, the impedance caused by the excessively long wires can be prevented, and the delay of adjusting voltages on the common electrode lines CS1 back to the original level does not arise. Moreover, the horizontal crosstalk phenomenon of the display images of the LCD panel 100 can be mitigated.

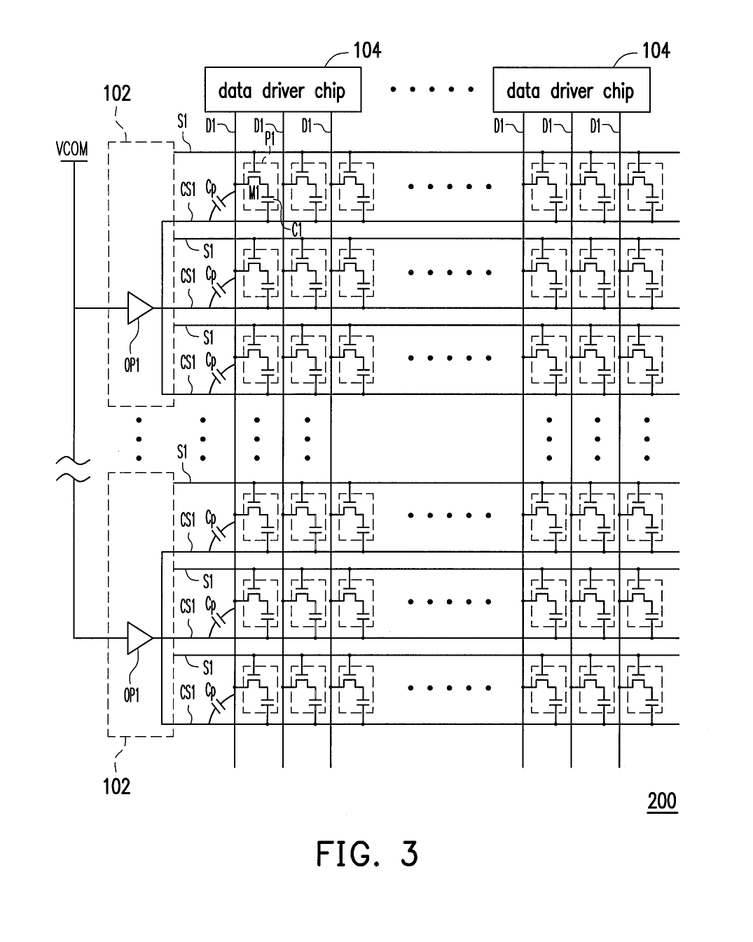

To be more specific, the LCD panel 100 is shown in FIG. 3. FIG. 3 is a schematic view illustrating an LCD panel 200 according to another embodiment of the invention. According to this embodiment, each of the pixel units P1 includes an active device M1 and a liquid crystal capacitor C1. The active device M1 can be a transistor, for instance. A control end of the active device M1 (e.g., the gate of the transistor) is coupled to a corresponding scan line S1. A first end and a second end of the active device M1 (e.g., the source and the drain of the transistor) are respectively coupled to a corresponding data line D1 and one end of the liquid crystal capacitor C1. The other end of the liquid crystal capacitor C1 is coupled to the corresponding common electrode line CS1.

In addition, each of the voltage regulating chips 102 of this embodiment includes an operation amplifier OP1 that is coupled between the regulated voltage VCOM and the common electrode lines CS1. An output end of each operation amplifier OP1 is coupled to three common electrode lines CS1. Similarly, during the scan period of the scan lines S1, the voltage regulating chip 102 outputs the scan driving signals to the scan lines S1, such that channels of the active devices M1 in the corresponding pixel units P1 are turned on. Thereby, the data signals of the data driver chip 104 can charge or discharge the liquid crystal capacitor C1 via the active devices M1, so as to change the orientation of the liquid crystal molecules in the LCD panel 200 and display images on the LCD panel 200. When the voltages on the common electrode lines CS1 are affected by the voltage coupling effects of the data lines D1, the output ends of the operation amplifiers OP1 in the voltage regulating chips 102 output the regulated current to the common electrode lines CS1 based on the regulated voltage VCOM, so as to rapidly adjust the voltages on the common electrode lines CS1 back to the original level and stabilize the voltages on the common electrode lines CS1.

The voltage regulating chip 102 described in the previous embodiment includes one operation amplifier OP1, which should not be construed as a limitation to the invention. The voltage regulating chip 102 can, as a matter of fact, include more operation amplifiers OP1 based on actual requirements. The more the number of the operation amplifiers OP1, the less the required number of the common electrode lines CS1 correspondingly coupled to each of the operation amplifiers OP1. Accordingly, a greater amount of the regulated current can be applied to the common electrode lines CS1 by the operation amplifiers OP1, and the voltages on the common electrode lines CS1 can be adjusted back to the original level in a relatively fast pace. Moreover, the voltage regulating chip 102 described in the previous embodiment includes but is not limited to the scan driver chip. Namely, the voltage regulating chip 102 can be individually configured at a location close to the voltage input terminals of the common electrode lines CS1, so as to prevent the linear impedance caused by the excessively long wires. As a result, the regulated current applied to the common electrode lines CS1 is not reduced, and the delay of adjusting the voltages back to the original level does not arise.

In light of the foregoing, the operation amplifier in the voltage regulating chip provides the regulated current to the common voltage lines at a close range, so as to prevent the linear impedance caused by the excessively long wires. Thereby, the regulated current applied to the common electrode lines is not reduced, and the delay of adjusting voltages back to the original level does not arise. As such, the voltages on the common voltage lines can be adjusted back to the normal level rapidly, and the horizontal crosstalk phenomenon of display images can be mitigated.

Although the invention has been described with reference to the above embodiments, it will be apparent to one of the ordinary skill in the art that modifications to the described embodiments may be made without departing from the spirit of the invention. Accordingly, the scope of the invention will be defined by the attached claims rather than by the above detailed descriptions.

What is claimed is:

1. A liquid crystal display panel comprising:
a plurality of scan lines;
a plurality of data lines;
a plurality of common electrode lines;
a plurality of pixel units respectively coupled to corresponding scan lines of the scan lines, corresponding data lines of the data lines, and corresponding common electrode lines of the common electrode lines; and
at least one voltage regulating chip coupled to a regulated voltage and the common electrode lines, so as to provide a regulated current to each of the common electrode lines based on the regulated voltage, respectively.

2. The liquid crystal display panel as recited in claim 1, wherein each of the one voltage regulating chip comprises:
at least one operation amplifier coupled between the regulated voltage and the common electrode lines, an output end of the operation amplifier outputting the regulated current based on the regulated voltage.

3. The liquid crystal display panel as recited in claim 1, wherein the voltage regulating chip is a scan driver chip.

4. The liquid crystal display panel as recited in claim 3, wherein the scan driver chip is further coupled to the scan lines and outputs a plurality of scan signals to the scan lines to drive the pixel units.

5. The liquid crystal display panel as recited in claim 1, wherein each of the pixel units comprises:
an active device, a control end of the active device being coupled to a corresponding scan line of the scan lines, a first end of the active device being coupled to a corresponding data line of the data lines; and
a liquid crystal capacitor coupled between a second end of the active device and a corresponding common electrode line of the common electrode lines.

6. The liquid crystal display panel as recited in claim 5, wherein each of the active devices is a transistor.

7. The liquid crystal display panel as recited in claim 1, further comprising:
at least one data driver chip outputting a plurality of data signals to the data lines to provide the pixel units with display data.
